(19) United States
(12) Patent Application Publication
(10) Pub. No.: US 2008/0106493 A1
(43) Pub. Date: May 8, 2008

(54) LASER DISPLAY HAVING REDUCED POWER CONSUMPTION AND METHOD OF OPERATING THE SAME

(75) Inventors: Lawrence E. Lach, Chicago, IL (US); Tomasz L. Klosowiak, Glenview, IL (US); Zili Li, Barrington, IL (US); George T. Valliath, Winnetka, IL (US); Dmitry Voloschenko, Schaumburg, IL (US); Min-Xian M. Zhang, Inverness, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/556,303

(22) Filed: Nov. 3, 2006

(51) Int. Cl. G09G 3/14

(52) U.S. Cl. 345/46

(57) ABSTRACT

A laser image projector display system (200) includes laser operating electronics (208, 210, 212, 400, 500, 700) that selectively operates a laser diode at a bias that is low enough to save energy based on analysis pixel brightness values. The laser bias may be high enough that laser can be transitioned to a lasing state in time to display a pixel, or the system can “look ahead” into a stream of pixels and adjust the bias in advance.

### FIELD OF THE INVENTION

The present invention relates generally to laser projectors.

### BACKGROUND

During the past decade handheld electronic devices such as mobile telephones, portable video player, personal digital assistants (PDA) and portable game consoles, have come into widespread use. Moreover, continued progress in electronic integration, has enabled the development of ever more powerful devices, to wit the handheld devices of today have processing power comparable to personal computers of a decade ago. Thus, it is possible for handheld electronic devices to run many useful applications that are run on personal computer, such as web browsers, image viewers and video players, for example. One limiting factor, in regards to handheld devices is their small screen size. The small screen size somewhat discourages prolonged use of text and graphics intensive applications. To address the small screen size, it has been proposed to incorporate small laser based image projectors within handheld devices. In order to be useful, especially in relatively brightly lit environments such as offices, a certain minimum screen brightness must be achieved. A particular chosen screen brightness and projected image size dictates a certain optical power from the laser. The inherent electrical-to-optical conversion efficiency of the laser in-turn dictates a certain electrical input power for the laser. In a handheld device this electrical input power must be supplied by a battery, fuel cell or other small power source, which also must provide power for other systems (e.g., the cellular radio) of the handheld device. Thus, there is a need for more efficient laser projector systems. More efficient laser projectors allow larger, brighter projected images, and/or extended battery life.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is sectional view of an example of a handheld electronic device in accordance with some embodiments of the invention;

FIG. 2 is a block diagram of a laser projector display system incorporated into the handheld electronic shown in FIG. 1 or other handheld device according to an embodiment of the invention;

FIG. 3 is a graph illustrating various characteristics of a laser diode used in the laser projector display system shown in FIG. 2 according to certain embodiments of the invention;

FIG. 4 is a block diagram of laser operating electronics used in the laser projector shown in FIG. 2 or other laser projector according to an embodiment of the invention;

FIG. 5 is a block diagram of laser operating electronics used in the laser projector shown in FIG. 2 or other laser projector according to another embodiment of the invention;

FIG. 6 is a flowchart of a method or software implemented in a decision logic block of the laser operating electronics shown in FIG. 5, or other laser operating electronics according to embodiments of the invention; and

FIG. 7 is a block diagram of laser operating electronics used in the laser projector shown in FIG. 2 or other laser projector according to yet another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to laser displays. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of laser displays described herein. The non-processor circuits may include, but are not limited to, signal drivers, clock circuits, power source circuits, and user input devices. As such, these functions may be interpreted as steps of a method to perform image signal processing for laser displays. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

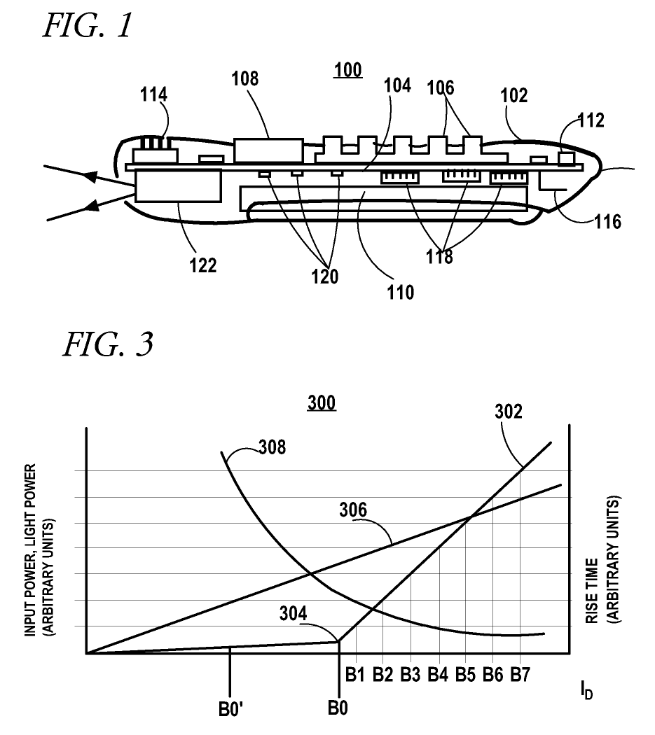

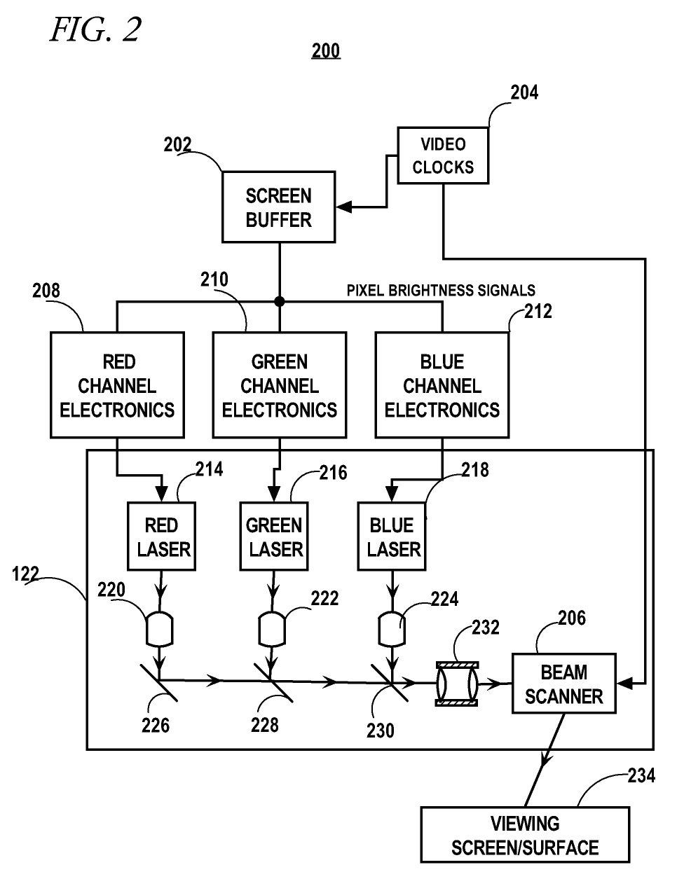

FIG. 1 is sectional view of an example of a handheld electronic device 100 in accordance with some embodiments of the invention. As shown in FIG. 1, the handheld electronic device 100 takes the form of a “candy bar” style mobile telephone, however alternatively the handheld electronic device 100 can take the form of a PDA, portable video player, handheld game console or other device. The electronic device 100 in the form of a mobile telephone comprises a housing 102 enclosing a circuit board 104, keypad 106, internal display 108, energy source (e.g., battery, fuel cell) 110, microphone 112, earpiece speaker 114, and internal antenna 116. The electronic device 100 also includes a laser projector display system 200 (FIG. 2). The laser projector display system 200 includes electronics in the form of integrated circuits 118 and optionally discrete components 120 mounted on the circuit board 104, and an optics module 122. The electronics and optics module are described in more detail with reference to FIG. 2.

FIG. 2 is a block diagram of a laser projector display system 200 incorporated into the handheld electronic shown in FIG. 1 or other handheld device according to an embodiment of the invention. An entry point of the system 200 is a screen buffer 202. Two dimensional arrays of discrete quantized digital pixel brightness values are written into the screen buffer 202. Each discrete quantized pixel brightness value typically is encoded in a plurality of binary bits (e.g., 8 bits) so that more than two (e.g., 256) intensity values can be encoded. Each two dimensional array represents a frame to be projected by the system 200. Separate two dimensional arrays can optionally be provided for each of multiple colors. Image data written into the screen buffer 202 may come from disparate sources. For example, an operating system of the device 100 may write pixel brightness values for background areas (known in the context of windows type operating systems as the desk top) and application window frames. Such areas may persist unchanged for many frames until some event (e.g., user input) that necessitates a change occurs. Areas of the projected display that include video can be written into the screen buffer 202 by specialized video decoder chips.

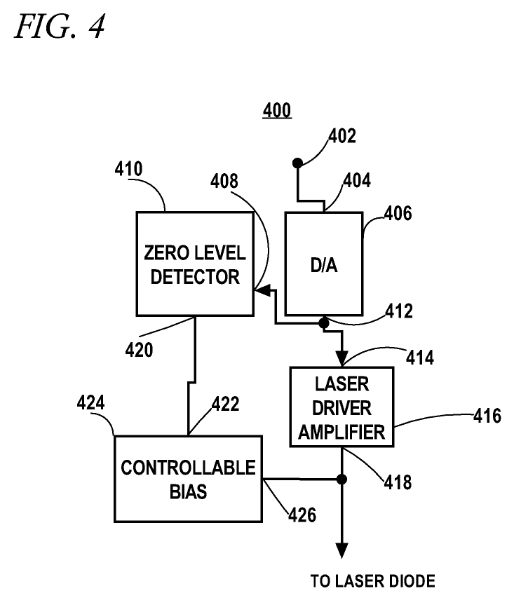

One or more video clocks 204, e.g., a pixel clock, a row clock and frame clock are coupled to the screen buffer 202 and to a beam scanner 206 (discussed further below). The video clocks 204 clock the pixel brightness values out of the screen buffer 202, into red channel electronics 208, green channel electronics 210, and blue channel electronics 212. Alternatively, one color is used for a monochrome display, two colors are used for a two color display, or more than three colors are used to achieve a display with an increased color gamut. The color channel electronics 208, 210, 212 are discussed in more detail below with reference to FIGS. 4-7.

The red, green and blue color channel electronics 208, 210, 212 are coupled respectively to a red laser diode 214, a green laser diode 216 and a blue laser diode 218. Briefly, the color channel electronics 208, 210, 212 serve to generate drive signals to drive the laser diodes 214, 216, 218 based on the pixel brightness values received from the screen buffer 202. Rather than using the light emitted by one or more of the laser diodes 214, 216, 218 directly, the light can be frequency multiplied (e.g., doubled) or used to pump another laser (e.g., a solid state laser).

Laser beams emitted by the red, green and blue laser diodes 214, 216, 218 are coupled through a red channel lens, 220, a green channel lens 222 and a blue channel lens 224 to a first mirror 226, a second, dichroic mirror 228, and a third, dichroic mirror 230. The red, green and blue channel lenses 220, 222, 224 serve to collimate or establish designed angles of divergence of the laser beams. In some cases, e.g., if the beams produced by the three laser diodes 214, 216, 218 are similar in diameter and divergence one or more of the channel lenses may be eliminated. The mirrors 226, 228, 230 serve to combine the laser beams emitted by the three laser diodes 214, 216, 218 into a single beam.

The combined single beam passes through an optional final lens 232 before impinging a beam scanner 206. The optional final lens 232 may be used if the red, green and blue channel lenses 220, 222, 224 are not used or may used in combination with the red, green and blue channel lenses. The beam scanner 206, can for example take the form of one or more piezoelectric mirror devices, MicroElectroMechanical System (MEMS) mirror devices, or rotating mirrors, for example. The beam scanner 206 scans the combined beam over a viewing screen or other surface 234. The beam scanner 206 suitably scans the combined beam in a raster pattern, but may alternatively use a vector pattern. The beam scanner 206 is kept in sync with pixel brightness values coming out of the screen buffer by supplying one or more signals from the video clocks 204 to the beam scanner 206.

The optics module 122 includes the laser diodes 214, 216, 218 channel lenses 220, 222, 224, mirrors 226, 228, 230, final lens 232, and beam scanner 206. The video clocks 204, screen buffer 202 and channel electronics 208, 210, 212 are embodied in the integrated circuits 118 and discretes 120 mounted on the circuit board 104.

Once skilled in the art will appreciate that many variations on the optical layout shown in FIG. 2 are possible.

FIG. 3 is a graph 300 illustrating various characteristics of typical laser diodes used in the laser shown in FIG. 2 according to an embodiment of the invention. In the graph 300 the abscissa indicates current consumption of the laser diode in arbitrary units. A first plot 302 indicates light output, in arbitrary units, versus current. A knee of the curve 304 is the lasing threshold. Below the threshold light is emitted at a very low intensity by spontaneous emission. Above the knee 304 lasing occurs, and light is emitted by stimulated emission. Above the knee 304 the intensity of light emitted by laser diodes is a linear function of the current. The abscissa is marked with nine current values B0′ B0-B7 which correspond to eight light intensity values. The light intensity levels at B0 and B0′ are both treated as equal to zero. Current level B0 corresponds to the lasing threshold, at which the emitted light intensity is approximately zero. Current levels B0-B7 are evenly spaced and yield approximately evenly spaced emitted light intensities. Although current levels B0-B7 are shown for illustration, in practice eight bits are typically used to encode pixel brightness values so that 256 light intensity levels can be encoded.

A second plot 306 gives power dissipation versus current. As shown even at the laser threshold B0 which corresponds to approximately zero emitted light intensity, the laser diode is dissipating substantial power. In a handheld electronic device this substantial power dissipation is undesirable as it leads to faster depletion of the energy source 110.

A third plot 308 represents rise time as a function of current. Above the laser threshold B0, plot 306 represents the small signal rise time, whereas below the laser threshold B0 the third plot 308 represents rise time from the current indicated on the abscissa for the third plot 306 to a lasing state at the lasing threshold B0. As shown rise time increases as the starting current decreases, and increases markedly below the lasing threshold B0. For some laser diodes, and for some starting currents the rise time to lasing at the laser threshold may exceed a pixel duration (inverse pixel rate). (Plot 306 is qualitative, not based on measured data.)

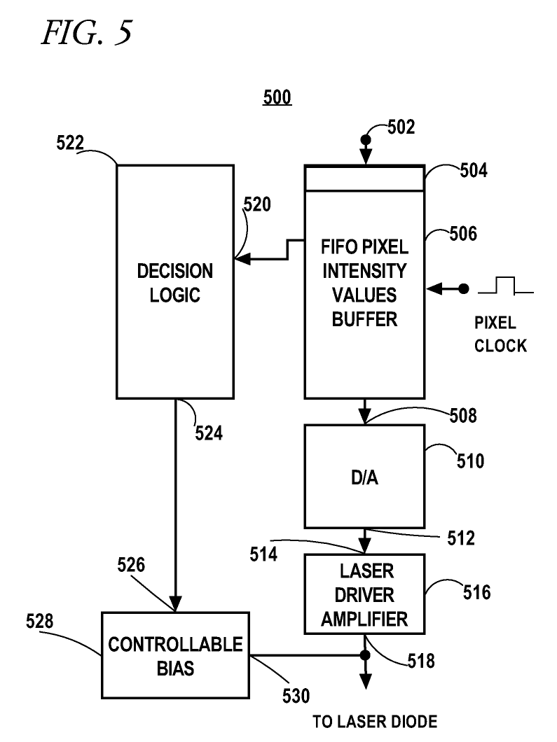

According to certain embodiments of the invention, a laser diode in a laser projection display system is selectively operated at the current level B0′ which is substantially below the lasing threshold, in response pixel brightness information indicating pixel brightness below a predetermined threshold. According to certain embodiments a laser diode in a laser projection system is operated at the current level B0′ in response to pixel brightness information indicating a pixel brightness of zero. In systems using quantized pixel brightness values, a pixel brightness below the lowest non-zero pixel brightness value is zero. According to certain embodiments B0′ is substantially lower than the lasing threshold B0. According to certain embodiments B0′ is less than two-thirds of the lasing threshold current B0. According to certain embodiments B0′ is less than one-half of the lasing threshold current B0. Setting a low value of B0′ serves to conserve energy of the energy source 110. According to certain embodiments B0′ is greater than zero. According to certain embodiments B0′ is substantially greater than zero and according to certain embodiments B0′ is greater than ⅓ of B0. In certain embodiments, setting a relatively high value of B0′ serves to reduce the total rise time from B0′ to a lasing state, thereby facilitating high pixel rates, which facilitates high resolution and high frame rates, which generally leads to higher display quality, without having to have recourse to the embodiments shown in FIGS. 5-7, or if these are used without having to look too far ahead in a pixel stream.

FIG. 4 is a block diagram of laser operating electronics 400 used in the laser projector shown in FIG. 2 or other laser projector according to an embodiment of the invention. The laser operating electronics 400 can be used for the red, green, and/or blue channel electronics 208, 210, 212 of the laser projector display system 200. The laser operating electronics 400 includes an input 402 which coupled to an input 404 of a digital-to-analog converter (D/A) 406. When used in the system 200, the input 402 receives the quantized, discrete, digital pixel brightness values from the screen buffer 202. An input 408 of a zero level detector 410 is coupled to an output 412 of the D/A 406. A comparator may be used as the zero level detector 410. As shown the zero level detector 410 is coupled to the input 402 of the laser color electronics 400 through the D/A 406 and therefore receives analog signals output by the D/A 406. Alternatively, the zero level detector 410 is coupled to the input 404 side of the D/A and receives and operates on quantized, discrete digital pixel brightness values. Alternatively, a level detector that detects pixel intensities below a low threshold, but not necessarily zero, is used instead of the zero level detector 410. In such an alternative pixel brightness below the low threshold will be effectively set to zero. The output 412 of the D/A 406 is also coupled to an input 414 of a laser driver amplifier 416. The laser driver amplifier 416 outputs a current based on a voltage output by the D/A 406. (A photodiode (not shown) monitoring the output of the laser diode may also be used to provide feedback to the laser driver amplifier 416.) An output 418 of the laser driver amplifier 416 is coupled to the laser diode (e.g., 214, 216, 218). An output 420 of the zero level detector 410 is coupled to a control input 422 of a controllable bias 424. An output 426 of the controllable bias 424 is coupled to the output 418 of the laser driver amplifier 416 and to the laser diode. A signal indicative of detection of a zero pixel brightness value that is generated by the zero level detector causes the controllable bias 424 to change the bias from B0 to B0′ thereby conserving energy as discussed above. Thus, if the laser projector display system 200 is being used to display content that includes dark areas, for the duration required for the laser to be scanned through pixels included in the dark areas, the laser bias will be reduced to B0′ thereby conserving energy of the energy source 110. This can be exploited if the user is using only a portion of the display for an application, and the remaining portion (e.g., a background or desktop) is dark. The laser operating electronics 400 shown in FIG. 4 are appropriate where the total rise time from the energy saving bias B0′ to a lasing state is less than the duration associated with a pixel (inverse pixel rate), or if the display quality can be reduced because the requirements are not stringent.

FIG. 5 is a block diagram of laser operating electronics 500 used in the laser projector shown in FIG. 2 or other laser projector according to another embodiment of the invention. The laser operating electronics 500 can be used for the red, green, and/or blue channel electronics 208, 210, 212 of the laser projector display system 200. The laser operating electronics 500 include an input 502 for receiving discrete, quantized digital pixel brightness values from the screen buffer 202. The input 502 is coupled to a first memory location 504 of a first-in-first-out (FIFO) buffer 506. A sequence of discrete quantized digital pixel brightness values that is received from the screen buffer 202 is clocked through the FIFO buffer 506 at a rate determined by a pixel clock signal received from the video clocks 204.

An output of the FIFO buffer 506 is coupled to an input 508 of a D/A 510. An output 512 of the D/A 510 is coupled to an input 514 of a laser driver amplifier 516. An output 518 of the laser driver amplifier 516 is coupled to the laser diode (e.g., 214, 216, or 218).

One or more memory locations of the FIFO are coupled to an input 520 of a decision logic block 522. An output 524 of the decision logic block 522 is coupled to a control input 526 of a controllable bias 528. An output 530 of the controllable bias 528 is coupled to the laser diode.

The decision logic block 522 decides whether to raise the laser bias current from an energy conserving level (e.g., B′) to a level that is at least the lasing threshold (e.g., B0) based on one or more of the discrete quantized digital pixel brightness values stored in the FIFO buffer 506. According to one embodiment the decision logic block 522 decides whether to raise the laser current by comparing the pixel brightness value in the first memory location 504 to a threshold (e.g., testing if the pixel brightness value in the first memory location is nonzero.) According to another embodiment the decision logic block 522 decides whether to raise the bias current based on pixel brightness values in multiple (e.g., the first N) memory locations in the FIFO buffer 506. For example, the decision logic block 522 can compare the sum of the pixel brightness values in multiple memory locations in the FIFO buffer 506 to a threshold, and if the sum exceeds the threshold raise the bias current. Alternatively, decision logic block 522 can perform spatial frequency analysis (e.g., using an Finite Impulse Response (FIR), or Fast Fourier Transform (FFT)) on pixel brightness values in multiple memory locations of the FIFO buffer. For example if a low-pass filtered amplitude is below a certain predetermined threshold, the bias current can be maintained at an energy conserving level. Note that the eye is relatively insensitive to variations in intensity of high spatial frequency components. Note that certain decision rules may be better suited for images and certain better suited for text. In cases that the pixel duration (inverse of the pixel clock rate) is smaller than the time required to transition the laser diode from the energy saving bias to a lasing state above the lasing threshold, then length of the FIFO buffer 506 can be set to provide enough time (pixel durations), between the time that a pixel brightness value reaches a last memory location used by the decision logic block 522 and the time that the pixel brightness value is output from the FIFO buffer 506, for the laser to be transitioned to the lasing state.

The decision logic block 522 can be implemented using state logic or a programmed processor for example. An example of the former is multiply-and-accumulate (MAC) unit which can be conveniently used to perform FIR or simple summing operations on pixel brightness values in a sequence of memory locations of the FIFO 506.

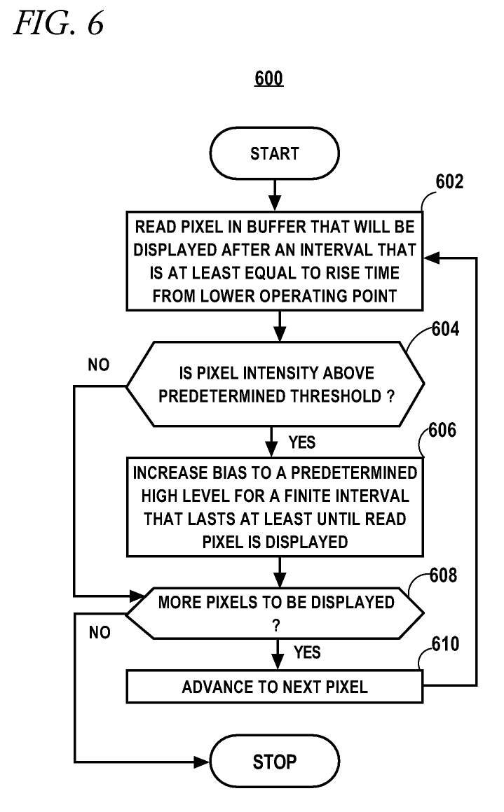

FIG. 6 is a flowchart of a method or software implemented in a decision logic block 522 of the laser operating electronics 500 shown in FIG. 5, or other laser operating electronics according to an embodiment of the invention. In block 602 a pixel brightness value that will be displayed after an interval that is at least about equal to a “rise time” is read. The “rise time” is the time required to transition the laser from operation at the energy saving bias B0′ (below lasing threshold) to a lasing state. According to certain embodiments the interval specified in block 602 is equal to the “rise time from the energy saving bias state to a maximum power lasing state of the laser (e.g., 214, 216, 218) used in the display system 200. In essence, block 602 “looks ahead” in the pixel stream. The FIFO buffer 506 is suitably made just the long enough so that a pixel brightness value will be pass through the FIFO buffer in an interval that is at least about equal to the “rise time”. If the FIFO buffer has such a length, then the pixel brightness value read in block 602 is suitably the pixel brightness value in the first memory location 504.

Block 604 is a decision block, the outcome of which depends whether the pixel brightness read in block 602 is higher than a predetermined threshold. According to certain embodiments, the predetermined threshold is zero. If the outcome of decision block 604 is negative, then the flowchart branches to decision block 608 which on depends if there are more pixel to be displayed, e.g., if more pixels are entering the FIFO buffer 506. If it is determined in block 608 that there are no more pixels to be displayed then the flowchart terminates. If, on the other hand, there are more pixels to be displayed then block 610 advances to the next pixel (e.g., another pixel brightness value is clocked into the FIFO buffer 506) and the flowchart returns to block 602. If it is determined in block 604 that the pixel brightness value is above the predetermined threshold, then the flowchart branches to block 606 in which the laser diode bias is increased to a predetermined higher level, at or above the laser threshold at least until the pixel corresponding to the pixel brightness value read in block 602 is displayed. Alternatively, the predetermined level may be so slightly below the laser threshold that adding a current increment coded by the lowest non-zero brightness level increases the laser current above the laser threshold. In the aforementioned embodiment in which the FIFO buffer 506 is made just long enough so that a pixel brightness value will be pass through the FIFO buffer in an interval that is at least about equal to the rise time, in block 606 the laser diode bias will be kept high at least until the pixel brightness value read in block 602 is clocked through the FIFO buffer, and converted by the D/A 510 to an analog voltage which is amplified by the laser driver amplifier 516 and drives the laser diode (e.g., 214, 216, 218). Thus, at the time the pixel brightness value is actually used to determine the laser diode current, the laser diode will be properly biased to access light emitting states on the linear portion of the light intensity plot 302 above the knee 304 (lasing threshold).

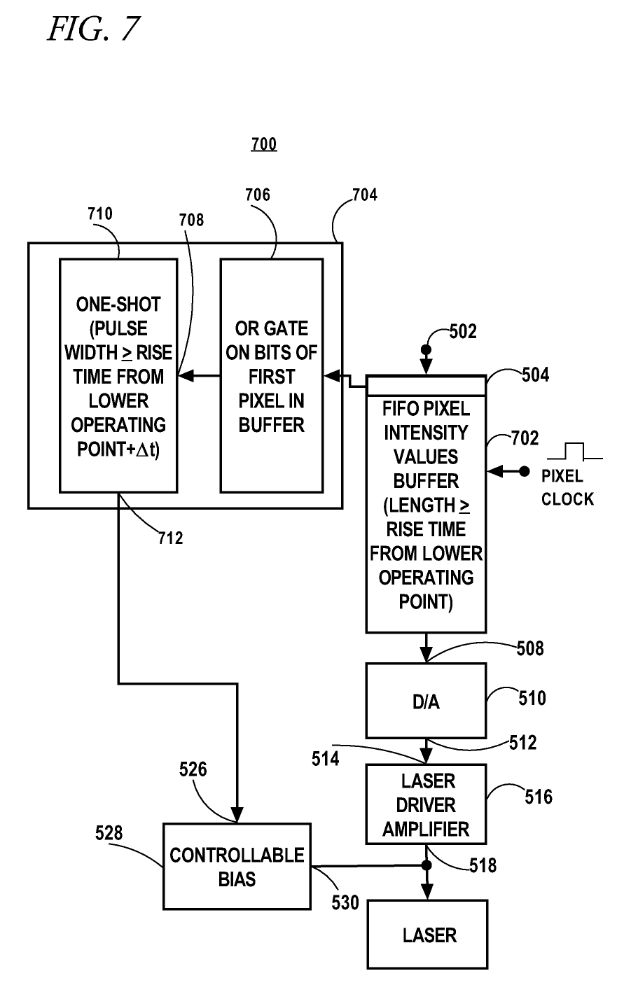

FIG. 7 is a block diagram of laser operating electronics 700 used in the laser projector shown in FIG. 2 or other laser projector according to yet another embodiment of the invention. The laser operating electronics 700 shown in FIG. 7 are similar to that shown in FIG. 5. The laser operating electronics 700 shown in FIG. 7 includes a FIFO buffer 702 that has a length (number of sequential memory locations) such that pixel brightness values, being shifted through sequential memory locations at the pixel clock rate, traverse the FIFO buffer 702 in at least about the time required to transition the laser from an energy saving state at current B0′ to a lasing state. The aforementioned FIFO buffer 702 traversal time, may be slightly less that the aforementioned time required to transition, especially in the cases that processing by the D/A 510 requires additional time that provides extra time for laser diode to transition to lasing, or some delay (e.g., a sub pixel time delay) in initiating lasing has a tolerable effect on display quality because the display quality specifications are not stringent.

A decision logic block 704 of the laser operating electronics 700 that is shown in FIG. 7 implements in hardware the bias control method or software shown in FIG. 6 in the form of a flowchart. The decision logic block 704 includes an OR gate 706 coupled to the bits of the first memory location 504 of the FIFO buffer 702. The OR gate 706 is used to check for non-zero pixel magnitudes. Note that if the OR gate 706 is connected to all the bits of the first memory location 504, decision block 704 implements a specific threshold, i.e., 0, whereas according to FIG. 6 the threshold need not be 0. The decision block 704 can also be altered to use a non-zero threshold, e.g., by not connecting one or more low order bits to the OR gate 706.)

The OR gate 706 is coupled to a trigger input 708 of a mono-stable multivibrator (“one shot”) 710. The one-shot 710 is a timer that outputs a pulse (active low or active high) of a predetermined duration starting whenever it is triggered. A pulse output 712 of the one-shot 710 is coupled to the control input 526 of the controllable bias circuit 528. In the laser operating electronics 700, the duration (or “width”) of the pulse output by the one-shot 710 is equal to the time required for a pixel magnitude value to propagate from the first memory location 504 through the FIFO buffer 702, and D/A 510 and be used to control driving of the laser diode, plus a pixel duration or more. When the OR gate 706 finds that the pixel magnitude in the first memory location 504 of the FIFO buffer 702 is non-zero it triggers the one-shot 710 which outputs a pulse to the controllable bias 528 which changes the bias on the laser diode from the energy saving bias B0′ to a bias B0 at or above the lasing threshold.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A display system comprising:
an image brightness information input adapted to receive image brightness information;
a laser diode for selectively illuminating in response to said image brightness information, wherein said laser diode has a lasing threshold at a first current consumption;
an electrical circuit coupled between said image brightness information input and said laser diode, wherein said electrical circuit is adapted to selectively drive said laser at a second current that is lower than said first current based on said image brightness information.

2. The display system according to claim 1 wherein said image brightness information comprises a sequence of discrete quantized digital pixel brightness values, wherein each discrete quantized digital pixel brightness value has a value selected from three or more brightness values, and said input is adapted to receive said sequence of discrete quantized digital pixel brightness values.

3. The display system according to claim 1 wherein said image brightness information comprises a sequence of discrete quantized digital pixel brightness values, wherein each discrete quantized digital pixel brightness value comprises at least two binary bits.

4. The display system according to claim 1 wherein:
said image brightness information comprises a sequence of discrete quantized digital pixel brightness values; and
said electrical circuit is adapted to drive said laser at said second current that is lower than said first current when said image brightness information indicates zero brightness.

5. The display system according to claim 1 wherein:
said second current is less than one-half said first current.

6. The display system according to claim 1 wherein:
said second current is at least one-third of said first current.

7. The display system according to claim 1 wherein:
said second current is less than two-thirds of said first current.

8. The display system according to claim 7 wherein:
said second current is at least one-third of said first current.

9. The display system according to claim 1 wherein:
said second current is greater than zero.

10. The display system according to claim 9 wherein:
said second current is substantially above zero.

11. The display system according to claim 1 wherein:
said electrical circuit is adapted to filter said image brightness information by frequency and selectively drive said laser at said second current based on one or more frequency components of said image brightness information.

12. The display system according to claim 11 wherein:
said electrical circuit is adapted to low-pass filter said image brightness information and selectively drive said laser at said second current based on a magnitude of an output of said low-pass filtering.

13. The display system according to claim 1 wherein:
said electrical circuit is adapted to drive said laser at said second current when said image brightness information indicates brightness below a predetermined brightness threshold.

14. The display system according to claim 13 wherein:
said electrical circuit comprises:
a level detector coupled to said input for detecting brightness below said predetermined brightness threshold;
a controllable bias circuit coupled to said level detector and said laser diode wherein said controllable bias circuit is responsive to said level detector for changing a bias current of said laser diode from at least about said first current to said second current in response to detection of brightness below said predetermined threshold.

15. The display system according to claim 14 wherein:
said image brightness information comprises a sequence of discrete quantized digital pixel brightness values;
said electrical circuit further comprises:
a digital-to-analog converter comprising:
an input coupled to said image brightness information input for receiving said digital pixel brightness values; and
a digital-to-analog converter output;
a laser diode driver amplifier comprising:
an input coupled to said digital-to-analog converter output; and
an laser diode driver amplifier output coupled to said laser diode.

16. The display system according to claim 13 wherein:
said second current is substantially lower than said first current.

17. The display system according to claim 16 wherein:
said image brightness information comprises a sequence of discrete quantized digital pixel brightness values
said electrical circuit is adapted to drive said laser at said second current when said image brightness information indicates zero brightness.

18. The display system according to claim 17 wherein said electrical circuit comprises:
a zero level detector coupled to said input;
an controllable bias circuit coupled to said zero level detector and said laser diode wherein said controllable bias circuit is responsive to said zero level detector for changing a bias current of said laser diode from at least about said first current to said second current in response to detection of a zero pixel brightness value.

19. The display system according to claim 18 wherein:
said electrical circuit further comprises:
a digital-to-analog converter comprising:
an input coupled to said image brightness information input for receiving said digital pixel brightness values; and
a digital-to-analog converter output;
a laser diode drive amplifier comprising:
an input coupled to said digital-to-analog converter output; and
a laser diode driver output coupled to said laser diode.

20. The display system according to claim 13 wherein:
said electrical circuit is adapted to drive said laser at said second current by default, and drives said laser above said second current in response to image brightness information indicating brightness at, at least, said predetermined brightness threshold.

21. The display system according claim 20 wherein:
said electrical circuit is adapted to start driving said laser above said second current, ahead of a time at which said laser is to be driven according to said brightness information, by a time increment that is at least about equal to a time required to transition said laser from a state associated with said second current to a state that produces said brightness at, at least said predetermined threshold.

22. The display system according to claim 21 wherein:
said image brightness information comprises a sequence of discrete quantized digital pixel brightness values;
said electrical circuit comprises:
a FIFO buffer through which said discrete quantized digital pixel brightness values pass at a rate equal to a pixel rate, wherein said FIFO buffer has first memory location that receives said digital pixel brightness values, wherein said FIFO has a length, such that a time required for one of said sequence of discrete quantized digital intensity values to pass through said FIFO is equal to said time increment;
a logic gate coupled to said first memory location for detecting pixel brightness values indicative of at, at least said predetermined threshold;
a timer coupled to said logic gate, wherein said timer sets a timer output signal to an active state for at least about said time increment in response to a signal produced by said logic gate, indicative of brightness at, at least said predetermined threshold;
a controllable bias circuit coupled to said timer, wherein said controllable bias circuit is adapted to change a bias current of said laser diode from said second current to at least about said first current in response to said active state of said signal of timer output signal.

23. The display system according to claim 22 wherein:
said electrical circuit further comprises:
a digital-to-analog converter comprising:
an input coupled to said image brightness information input for receiving said digital pixel brightness values; and
a digital-to-analog converter output;
a laser diode drive amplifier comprising:
an input coupled to said digital-to-analog converter output; and
a laser diode driver output coupled to said laser diode.

24. A method of driving a laser diode of a display, the method comprising:
receiving image brightness information;
checking if said image brightness information indicates a brightness level above a predetermined value, and if so:
increasing a bias of said laser diode from below a lasing threshold of said laser diode.

25. The method of driving a laser diode of a display according to claim 24, wherein:
checking if said image brightness information indicates said brightness level above said predetermined threshold comprises checking if said brightness information indicates that said brightness level is above zero.

26. The method of driving a laser diode of a display according to claim 24, wherein increasing said bias of said laser diode from below said lasing threshold of said laser diode comprises:
increasing said bias of said laser diode from between one-third and two-thirds of said lasing threshold.

27. The method of driving a laser diode of a display according to claim 24, wherein:
increasing said bias of said laser diode from below said lasing threshold of said laser diode comprises:
increasing said bias of said laser diode from a value substantially below said lasing threshold.

28. The method of driving a laser diode of a display according to claim 27, wherein:
increasing said bias of said laser diode from a value substantially below said lasing threshold comprises:
increasing said bias of said laser diode from a value substantially above zero.

29. The method of driving a laser diode of a display according to claim 24, wherein:
increasing said bias of said laser diode from below said lasing threshold of said laser diode comprises:
increasing said bias of said laser diode from a value substantially above zero.

30. The method of driving a laser diode of a display according to claim 24 further comprising:
driving said laser diode at a level indicated by said image brightness information;
and wherein:
receiving image brightness information, comprises receiving said brightness information in advance of driving said laser diode at said level indicated by said image brightness information by a time interval that is at least equal to a time required to initiate lasing.

31. The method of driving a laser diode of a display according to claim 30 wherein:
increasing said bias of said laser diode from below said lasing threshold of said laser diode, comprises increasing said bias when said image brightness information is received.
